(19) United States
(12) Patent Application Publication
(10) Pub. No.: US 2006/0164677 A1
(43) Pub. Date: Jul. 27, 2006

(54) Image forming apparatus and a method of controlling a job processing order

(76) Inventor: Seong-ku Ahn, Suwon-si (KR)

Correspondence Address: STANZIONE & KIM, LLP, 919 18TH STREET, N.W., SUITE 440, WASHINGTON, DC, 20006, US

(21) Appl. No.: 11/330,289

(22) Filed: Jan. 12, 2006

(30) Foreign Application Priority Data
Jan. 22, 2005 (KR) 2005-6041

(51) Int. Cl. G06F 3/12

(52) U.S. Cl. 358/1.15

(57) ABSTRACT

An image forming apparatus and a method of controlling a job processing order in the image forming apparatus. The method includes receiving a plurality of job data from at least one host computer, assigning a first weight to each of the plurality of job data by applying a manager-defined weight table, assigning a second weight to each of the plurality of job data by applying a user-defined weight table, summing the first weight and the second weight of assigned to each job data to calculate a weight sum for each job data, and determining a job processing order of the plurality of job data according to the weight sum of each job data. Accordingly, a user of the host computers can determine the job processing order by additionally applying the second weight to job data determined to be more urgent based on urgency of the job data and therefore efficiency using the image forming apparatus can be improved.

### CROSS-REFERENCE TO RELATED APPLICATIONS

This application claims the benefit under 35 U.S.C. § 119(a) of Korean Patent Application No. 2005-6041, filed Jan. 22, 2005, the entire contents of which are incorporated herein by reference.

### BACKGROUND OF THE INVENTION

1. Field of the Invention

The present general inventive concept relates to an image forming apparatus and a method of controlling a job processing order. More particularly, the present general inventive concept relates to an image forming apparatus usable with a network image forming system, that determines a job processing order according to a weight of job data, which is determined according to job attribute information of the job data, and a method thereof.

2. Description of the Related Art

In a general network image forming system, at least one image forming apparatus and one or more host computers are interconnected through a local area network (LAN). Thus, since the one or more host computers can share a single image forming apparatus, the image forming apparatus can be utilized more efficiently in the general network image forming system. The at least one image forming apparatus includes a printer or a multi-function peripheral (MFP) that can perform a combination of more than one function of a scanner, a printer, a facsimile and a photocopier.

In the network image forming system, when the host computers request various jobs such as printing, copying, faxing and scanning through the network, the image forming apparatus performs the jobs in an order of arrival times of the jobs requested from the host computers.

However, for example, when a request of a printing job to print a hundred sheets of paper arrives earlier than a request of a faxing job, which is more urgent, the faxing job is not executed until the hundred sheets are all printed regardless of the faxing job's urgency.

Furthermore, due to differences of users' tasks and positions, significance and urgency of respective jobs may vary according to the users who request the jobs. Therefore, when the jobs are performed in the order of the arrival times thereof without considering urgency of the respective jobs, efficiency of the job performance is deteriorated.

### SUMMARY OF THE INVENTION

The present general inventive concept provides an image forming apparatus to determine a job processing order according to a weight of job data, which is determined according to job attribute information of the job data, and a method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of controlling a job processing order in an image forming apparatus, the method comprising receiving a plurality of job data from at least one host computer, providing a first weight to each of the plurality of job data by applying a manager-defined weight table, providing ing a second weight to each of the plurality of job data by applying a user-defined weight table, summing the first weight and the second weight of each job data to calculate a weight sum for each job data, and determining a job processing order of the plurality of job data according to the weight sum of each job data.

The user-defined weight table may be received from the at least one host computer. The manager-defined weight table may comprise weights determined according to job attribute information and may be pre-stored in the image forming apparatus.

The weights according to the job attribute information may comprise at least one weight assigned to at least one of the host computers having the job data, according to a user ID and a job type.

The job type may comprise at least one of printing, faxing, copying, scanning, and mailing.

The at least one weight according to the user ID and the job type may be determined according to at least one of positions, tasks, and company-service years of users of the at least one host computer.

Each job data of the plurality of job data may include the corresponding job attribute information.

The method may further comprise updating the job processing order when at least one of a new job data and new user-defined weight table is received from the at least one host computer.

The foregoing and/or other aspects of the present general inventive concept may also be achieved by providing a method of controlling a job processing order in an image forming apparatus, the method comprising receiving a plurality of job data from at least one host computer, and determining a job processing order by applying a manager-defined weight table comprising weights determined according to job attribute information of each job data of the received plurality of job data.

The manager-defined weight table may comprise weights determined according to the job attribute information and may be pre-stored in the image forming apparatus.

The weights may comprise weights associated to the at least one of the host computers having the job data and determined according to a user ID and a job type.

The determining of the job processing order may comprise arranging the plurality of job data based on a first weight according to the user ID of the manager-defined weight table, rearranging the job data having the same user IDs based on a second weight determined according to the job type of the manager-defined weight table, and determining the job processing order of the plurality of job data according to the arranged order.

The determining of the processing order may comprise arranging the plurality of job data based on the first weight determined according to the job type in the manager-defined weight table, rearranging job data having the same job type among the arranged plurality of job data based on the second weight determined according to the job type in the manager-defined weight table, and determining the job processing order of the job data according to the arranged order.

The foregoing and/or other aspects of the present general inventive concept may also be achieved by providing an image forming apparatus comprising a queue part to stack job data received from at least one host computer, and a job management part to determine a job processing order of the job data by applying to the received job data at least one user-defined weight table and a manager-defined weight table comprising weights determined according to job attribute information.

Here, the manager-defined weight table may comprise weights determined according to the job attribute information and may be pre-stored in the image forming apparatus.

The weights determined according to the job attribute information may comprise weights corresponding to the at least one of the host computers having the job data, according to a user ID and a job type.

The job management part may arranged the job data based on a first weight determined according to user ID in the manager-defined weight table and rearranges the job data having the same user IDs among the job data based on a second weight according to the job type in the manager-defined weight table, thereby determining the job processing order of the job data according to a resulting arranged order of the job data.

The job management part arranges the job data based on the first weight according to the job type in the manager-defined weight table and rearranges job data having the same job type among the job data based on the second weight according to the user ID in the manager-defined weight table, thereby determining the job processing order of the job data according to a resulting arranged order of the job data.

The foregoing and/or other aspects of the present general inventive concept may also be achieved by providing an image forming apparatus comprising a queue part to stack job data received from at least one host computer, and a job management part to determine a job processing order of the job data by applying to the received job data at least one user-defined weight table and a manager-defined weight table comprising weights determined according to job attribute information.

The job management part may provide a first weight and a second weight to the received job data using the manager-defined weight table and the user-defined weight table, and sums the first and second weights to calculate a summed weight and determines the job processing order of the job data according to the summed weight.

When at least one of new job data and a new user-defined weight table is received from the at least one host computer, the job management part may update the job processing order of the newly received job data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically illustrating a network image forming system having an image forming apparatus according to an embodiment of the present general inventive concept;

FIG. 2 is a block diagram illustrating a host computer and the image forming apparatus in the network image forming system of FIG. 1;

FIG. 3 is a flowchart illustrating a method of controlling an order of image forming jobs according to an embodiment of the present general inventive concept; and

FIG. 4 is a flowchart illustrating a method of controlling an order of image forming jobs according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

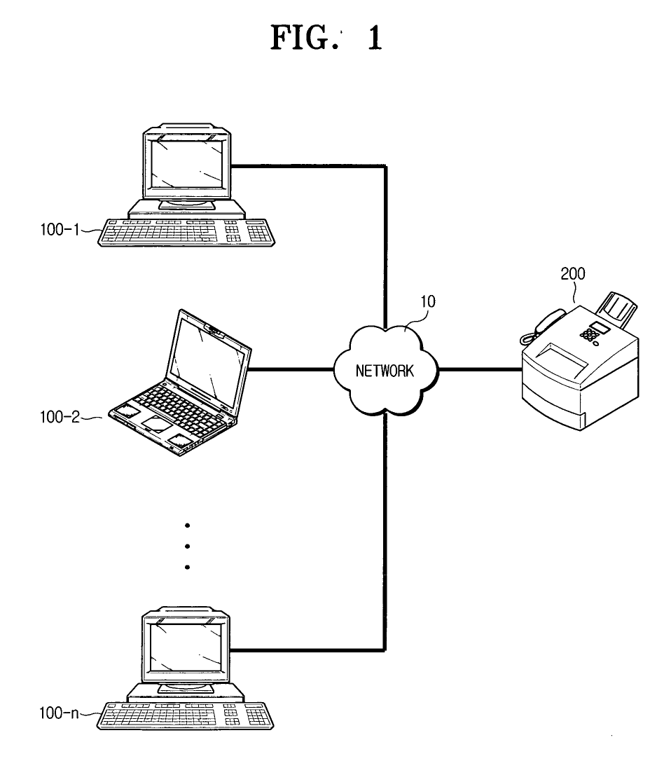

Referring to FIG. 1 illustrating a network image forming system which comprises first through n-th computers 100-1, 100-2, . . . , 100-n and an image forming apparatus 200 according to an embodiment of the present general inventive concept. The image forming apparatus 200 is communicably connected to a plurality of host computers, that is, the first host computer 100-1 to the n-th host computer 100-n, through a network 10. The network 10 may comprise a local area network (LAN), a share such as hub, and the Internet.

The plurality of host computers 100-1 to 100-n generate job data and transmit the job data to the image forming apparatus 200. The job data refers to data converted from a document prepared by the first to the n-th host computers 100-1 to 100-n. The converted data may be recognizable by the image forming apparatus 200 to perform a job, such as printing or faxing, with respect to the prepared document. The job data may comprise data to request or perform other jobs such as copying and scanning.

The job data of a job includes information on a job attribute (i.e., job attribute information). The job attribute information comprises information on a user's identification (ID) allocated by a system manager to the host computer generating the job data, information on a job type, such as printing, faxing, copying and scanning, and information on additional functions applied to the job. Through the job data, the image forming apparatus 200 can recognize the user, the job type, and the additional functions applied to the job data transmitted from one of the first to the n-th host computers 100-1 to 100-n.

Hereinbelow, an operation of the image forming apparatus 200 will be described with reference to a printing job and a faxing job for conciseness of explanation. However, it should be understood that the present general inventive concept is not intended to be limited to printing jobs and faxing jobs, and the present general inventive concept can be applied when the image forming apparatus 200 performs other jobs, such as scanning and copying.

When the job data of jobs for printing or faxing are input from one or more of the first to the n-th host computers 100-1 to 100-n, the image forming apparatus 200 determines a job processing order of the input job data by applying a manager-defined weight table, which is pre-stored in the image forming apparatus 200 the table including weights allocated according to respective user IDs and job types, so that the image forming apparatus generates a job execution list according to the job processing order. Then, the image forming apparatus 200 processes the jobs based on the job execution list.

When a user-defined weight table is input from at least one of the plurality of first to the n-th host computers 100-1 to 100-n, the image forming apparatus 200 determines the job processing order of the input job data by further applying the user-defined weight table so that the image forming apparatus updates the job execution list. The method in which the image forming apparatus 200 determines the job processing order with respect to the input job data, will now be described below in greater detail.

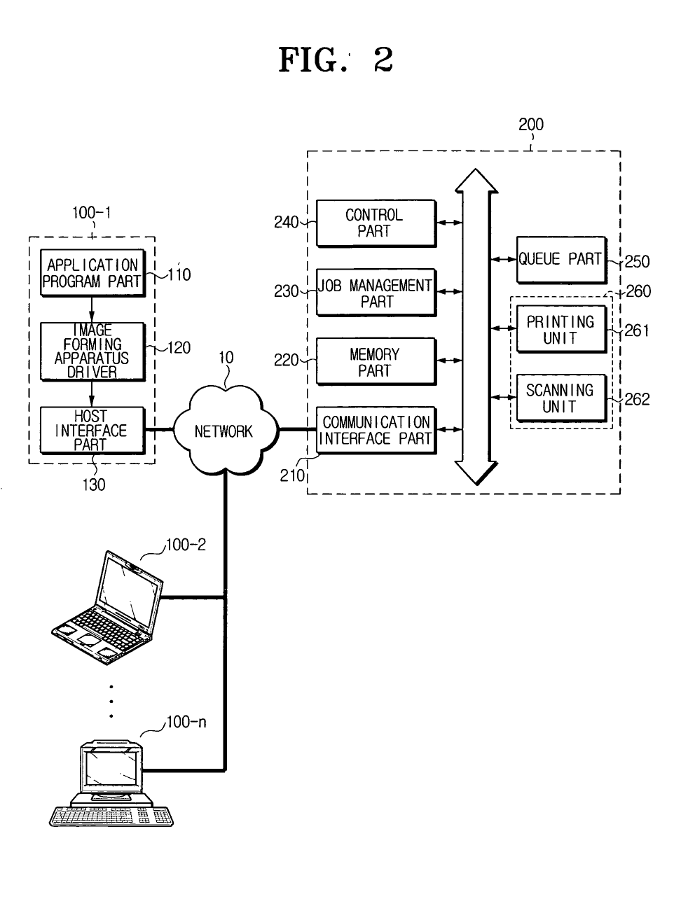

FIG. 2 is a block diagram illustrating the first host computer 100-1 and the image forming apparatus 200 in the network image forming system of FIG. 1.

Referring to FIGS. 1 and 2, the first host computer 100-1 comprises an application program part 110, an image forming apparatus driver 120 and a host interface part 130.

The application program part 110 provides an application program enabling the user to generate a document and an image. The application program may comprise a word processing program, for example, Hangul, which is a Korean word processing program, Excel and Microsoft Word. Additionaly, the application program part 110 provides a table of a predetermined format (e.g., Table 1) to prepare the user-defined weight table, as follows:

TABLE 1

| | | Job type | | | | |
|---|---|---|---|---|---|---|
| | | Print | | | | |
| | user-defined | | enlargement/ | | fax | |
| user ID | weight | pages | reduction | paper | pages | phone No. |
| 573456 | 9 | 10 | 150% | A4 | | |
| 573456 | 2 | 6 | 70% | B5 | | |
| 573456 | 9 | | | | 3 | 555-5555 |
| 573456 | 4 | 7 | 100% | A4 | | |

In [Table 1], the user provides or assigns a weight to a job desired to be performed according an urgency of the job.

According to [Table 1], a user of the first host computer 100-1 having a user ID ‘573456’ (allocated by the system manager) assigns or provides ‘9’ as a user-defined weight on a printing job of which the number of pages is 10, of which an enlargement/reduction rate is 150%, and a paper size is A4. Also, the user of the first host computer 100-1 (having user ID ‘573456’) assigns the user-defined weight ‘9’ to a faxing job of which the number of pages is 3 and a destination number is 555-5555. Here, the user ID is assigned to the first host computer 100-1 by the system manager and therefore the user ID may not be changed by the user.

[Table 1] is an exemplary illustration of the user-defined weight table. Therefore, a structure of the user-defined weight table can be variable according to additional items of the printing and faxing jobs to be performed by the image forming apparatus 200. For example, if an N-up function is provided by the image forming apparatus 200 as an additional function, a corresponding item may be added to the user-defined weight table. The application program part 110 is provided with information on the structure of the user-defined weight table by the image forming apparatus driver 120.

The image forming apparatus driver 120 converts the document to the job data using driver programs regarding the image forming apparatus 200 and includes the job attribute information in the job data. In addition, the image forming apparatus driver 120 converts the user-defined weight table prepared by the application program part 110 to data recognizable by the image forming apparatus 200 and transmits the data corresponding to the Table 1 to the image forming apparatus 200.

The host interface part 130 functions as a passage to exchange data regarding the printing job between the first host computer 100-1 and a communication interface part 210 of the image forming apparatus 200. According to the present embodiment, the job data and the user-defined weight table are transmitted to the image forming apparatus 200 through the host interface part 130.

The image forming apparatus 200 capable of controlling the job processing order, according to an embodiment of the present general inventive concept, comprises the communication interface part 210, a memory part 220, a job management part 230, a control part 240, a queue part 250, and a job process part 260. The job process part 260 includes a printing unit 261 and a scanning unit 262.

The communication interface part 210 transceives (i.e., transmits and receives) data between the image forming apparatus 200 and the first to the n-th host computers (100-1 to 100-n). Additionally, the communication interface part 210, may be connected to a public switched telephone network (PSTN) and transmits fax data from the image forming apparatus 200 to a destination fax telegraph (not shown). In the present embodiment, the communication interface part 210 receives the job data and the user-defined weight table from the first to the n-th host computers 100-1 to 100-n.

The memory part 220 stores a variety of programs to operate the image forming apparatus 200. More specifically, the manager-defined weight table comprising the weights according to the user ID and the job type (as illustrated in [Table 2] below) is pre-stored in the memory part 220. Also, the user-defined weight table is received from the first to the n-th host computers 100-1 to 100-n and stored in the memory part 220.

TABLE 2

| Jog type | Weight | User ID | Weight |
|---|---|---|---|
| Fax | 5 | 573456 | 15 |
| Copy | 4 | 346757 | 13 |
| Print | 3 | 234548 | 9 |
| Scan | 2 | . . . | . . . |
| Others | 1 | . . . | . . . |

The manager-defined weight table is input by the system manager and pre-stored in the image forming apparatus 200. Here, the weights corresponding to the user ID may be determined according to positions, tasks and years of company's service of the users of the first to the n-th host computers 100-1 to 100-n.

The job management part 230 determines the job processing order of the job data stacked in the queue part 250 by applying the manager-defined weight table and the user-defined weight table. Hereinbelow, a method of determining the job processing order by the job management part 230 is described with reference to a table [Table 3], where the job data are stacked in the queue part 250.

TABLE 3

| Job | Job type | Queue order |
|---|---|---|
| Job1 | print 2p 70% B5 (from 234548) | 1 |
| Job2 | fax 3p 555-5555 (from 573456) | 2 |
| Job3 | print 3p 100% A4 (from 346757) | 3 |
| Job4 | print 20p 100% A4 (from 573456) | 4 |

Referring to [Table 3], the job data ‘Job1’ on a first line in the queue part 250 is a printing job request made by a host computer with the user ID ‘234548’, to print 2 pages with an enlargement/reduction rate of 70% on a paper having a B5 format. The job data ‘Job 2’ is a faxing job on a second line in the queue part 250 and is a request made by a host computer with the user ID ‘573456’ to fax 3 pages to the destination number 555-5555.

The job management part 230 assigns weights, according to the user ID and the job types, to the job data stacked in the queue part 250 by applying the manager-defined weight table and the user-defined weight table and summing the weights. Therefore, the job management part 230 determines the job processing order by providing or assigning a higher priority to job data with a higher sum of the weights. When determining the job processing order, the job manager part 230 may also consider a weight of the job data according to the stacked or stored order in the queue part 250.

When the job data in the queue part 250 have user-defined weights according to the user-defined weight tables transmitted from the respective host computers 100-1 to 100-n, the user-defined weights are also added in determining the job processing order, thereby determining the job execution list.

Accordingly, the management part 230 determines the job execution list with respect to the job data stacked in the queue part 250, as illustrated in a table [Table 4] below.

TABLE 4

| | | Weight | | | | |
|---|---|---|---|---|---|---|
| | | | | | User- | |
| Processing | | | | Queue | defined | |
| order | Job | User ID | Job types | order | weight | Sum |
| 1 | Job2 | 15 | 5 | 3 | 9 | 32 |
| 2 | Job3 | 13 | 3 | 2 | 6 | 24 |
| 3 | Job1 | 9 | 3 | 4 | 5 | 21 |
| 4 | Job4 | 15 | 3 | 1 | — | 19 |

Here, the job data ‘Job4’ is not defined in the user-defined weight table transmitted from the host computers. Therefore, the user-defined weight is not considered with respect to the job data ‘Job4.’

The control part 240 controls the overall operations of the image forming apparatus 200. According to the present embodiment, the control part 240 controls the job process part 260 to perform the printing jobs and the faxing jobs with respect to the job data stacked in the queue part 250 based on the job execution list prepared by the job management part 230.

The job process part 260 performs printing, scanning, faxing and copying with respect to the job data stacked in the queue part 250 based on the job execution list under the control of the control part 240. The job process part 260 comprises the printing unit 261 to print data on a paper and the scanning unit 262 to read image data from a document by scanning the document.

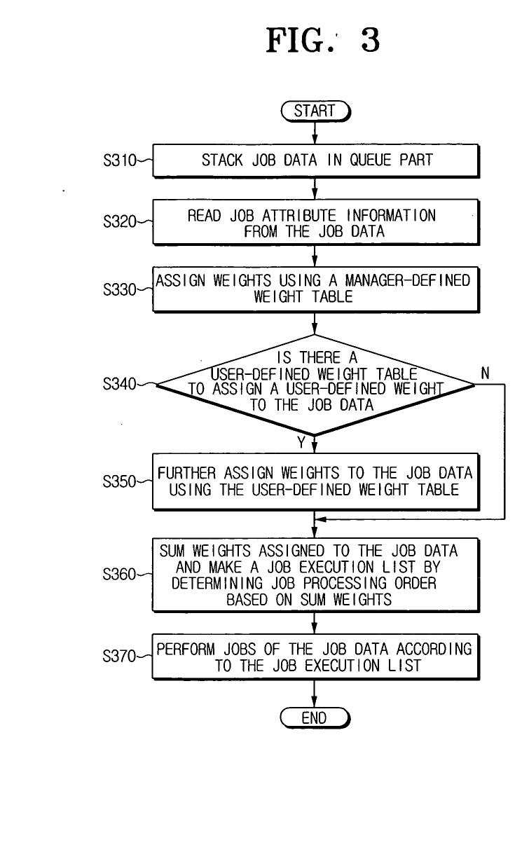

FIG. 3 is a flowchart illustrating a method of controlling an order of image forming jobs according to an embodiment of the present general inventive concept.

Referring to FIGS. 2 and 3, the job data are transmitted from the first to the n-th host computers (100-1 to 100-n) and stacked in the queue part 250 (operation S310). The job management part 230 reads out the job attribute information from the job data stacked in the queue part 250 (operation S320) and provides or assigns weights to the job data using the manager-defined weight table according to the read job attribute information (operation S330).

The job management part 230 checks whether the user-defined weights with respect to the job data stacked in the queue part 250 are defined in the user-defined weight tables transmitted from the first to the n-th host computers, that is, 100-1 to 100-n (operation S340). When the user-defined weights are defined, the job management part 230 additionally applies the user-defined weights to the corresponding job data (operation S350).

The job management part 230 sums the weights assigned to the respective job data to generate weight sums and determines the job processing order by giving a higher priority to a job having a higher weight sum. Accordingly, the job management part 230 determines the job execution list (operation S360).

Finally, the control part 240 controls the job management part 260 to perform the jobs of the job data according to the job processing order determined in the job execution list as prepared by the job management part 230 (operation S370).

The job processing order and the job execution list may be updated whenever new job data is transmitted from at least one of the first to the n-th host computers (100-1 to 100-n) and stacked in the queue part 250 or whenever a new user-defined weight table is input from at least one of the first to the n-th host computers 100-1 to 100-n (operation S360). Alternatively, the weights according to the stacked order in the queue part 250 may also be applied in determining the job processing order.

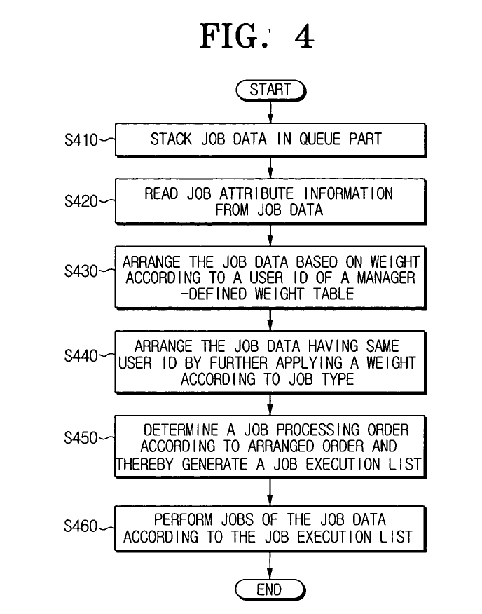

FIG. 4 is a flowchart illustrating a method of controlling a job processing order of an image forming apparatus, according to an embodiment of the present general inventive concept.

Referring to FIGS. 2 and 4, the job data are transmitted from the first to the n-th host computers (100-1 to 100-n) and stacked in the queue part 250 (operation S410). The job management part 230 reads out the job attribute information regarding the user ID and the job type from each of the job data stacked in the queue part 250 (operation S420).

The job management part 230 arranges the job data according to the weights associated to the user ID in the manager-defined weight table (operation S430). When a plurality of job data have the same user ID, the job management part 230 rearranges the job data having the same user ID by further applying a weight according to the job type in the manager-defined weight table (operation S440). That is, when two job data have the same user ID, jobs corresponding to the two job data may be performed using weights determined according to job types.

The job management part 23 determines the job processing order based on how the job data are arranged, thereby generating the job execution list (operation S450).

Finally, the control part 240 controls the job management part 260 to perform the jobs of the job data according to the job processing order determined in the job execution list that is prepared by the job management part 230 (operation S460).

According to the present embodiment, the job data are arranged first based on the weights according to the user ID and then rearranged based on the weights according to the job type. Alternatively, the weights according to the job type may be applied first and the weights according to the user ID next with respect to the job data having the same job type.

As can be appreciated from the above description, according to embodiments of the present general inventive concept, the manager-defined weight table comprising the weights according to the user ID and the job types and prepared by the system manager is pre-stored in the image forming apparatus 200 and used to determine the job processing order of the job data transmitted from the host computers. Consequently, since job data of greater urgency can be processed in advance, efficiency in using the network image forming apparatus 200 can be improved.

Furthermore, the network image forming apparatus 200 can be more effectively utilized by rearranging the job processing order by further applying the user-defined weight table with respect to a plurality of job data determined to be urgent by the users of the respective host computers.

The embodiments of the present general inventive concept can also be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, the job management control part 230 (see FIG. 2) of the image printing apparatus 200 may be embodied in software, hardware, or a combination thereof.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling a job processing order in an image forming apparatus, comprising:
receiving a plurality of job data from at least one host computer;
assigning a first weight to each of the plurality of received job data using a manager-defined weight table;
assigning a second weight to each of the plurality of received job data using a user-defined weight table;
summing the first and the second weight assigned to each of the plurality of job data to calculate a corresponding weight sum; and
determining a job processing order of the plurality of job data according to the weight sum.

2. The method of claim 1, wherein the user-defined weight table is received from the at least one host computer.

3. The method of claim 2, wherein the manager-defined weight table comprises weights determined according to job attribute information and pre-stored in the image forming apparatus.

4. The method of claim 3, wherein the weights determined according to the job attribute information comprise at least one weight assigned to the at least one of the host computers outputting the job data, determined according to a user ID and a job type.

5. The method of claim 4, wherein the job type comprises at least one of printing, faxing, copying, scanning, and mailing of the job data.

6. The method of claim 3, wherein the weight corresponding to the user ID and the job type is determined according to at least one of positions, tasks and years of company's service of users of the at least one host computer.

7. The method of claim 3, wherein each of the plurality of job data includes corresponding job attribute information.

8. The method of claim 3, further comprising: t
updating the job processing order when at least one of new job data and a new user-defined weight table is received from the at least one host computer.

9. A method of controlling a job processing order in an image forming apparatus, the method comprising:
receiving job data from at least one host computer; and
determining a job processing order by applying a manager-defined weight table comprising weights determined according to job attribute information to the received job data.

10. The method of claim 9, wherein the manager-defined weight table comprises weights determined according to the job attribute information and is pre-stored in the image forming apparatus.

11. The method of claim 10, wherein the weights determined according to the job attribute information comprise weights assigned to the at least one of the host computers outputting the job data, according to a user ID and a job type.

12. The method of claim 11, wherein determining of the job processing order comprises:
arranging the job data based on a first weight determined according to the user ID of the manager-defined weight table;
rearranging the job data having the same user IDs based on a second weight determined according to the job type of the manager-defined weight table; and
determining the job processing order of the job data according to the arranged order.

13. The method of claim 11, wherein determining of the job processing order comprises:
arranging the job data based on a first weight determined according to the job type in the manager-defined weight table;
rearranging the job data having the same job type based on a second weight determined according to the user ID in the manager-defined weight table; and
determining the job processing order of the job data according to the arranged order.

14. An image forming apparatus comprising:
a memory part to store a manager-defined weight table which comprises weights determined according to job attribute information;
a queue part to stack job data received from at least one host computer; and
a job management part to determine a job processing order of the job data by applying the manager-defined weight table to the job data stacked in the queue part.

15. The image forming apparatus of claim 14, wherein the weights according to the job attribute information comprise weights assigned to the at least one host computer outputting the job data, according to a user ID and a job type.

16. The image forming apparatus of claim 15, wherein the job management part arranges the job data based on a first weight determined according to user ID in the manager-defined weight table and rearranges the job data having the same user IDs among the job data based on a second weight determined according to the job type of the manager-defined weight table, so that the job processing order of the job data according to the arranged order.

17. The image forming apparatus of claim 15, wherein the job management part arranges the job data based on a first weight determined according to the job type in the manager-defined weight table and rearranges the job data having the same job type among the job data based on a second weight determined according to the user ID in the manager-defined weight table, so that the job processing order of the job data is determined according to the arranged order.

18. An image forming apparatus, comprising:
a queue part to stack job data received from at least one host computer; and
a job management part to determine a job processing order of the received job data by applying to the received job data a manager-defined weight table and at least one user-defined weight table comprising weights determined according to job attribute information.

19. The image forming apparatus of claim 18, wherein the job management part assigns a first weight to the received job data by applying the manager-defined weight table and assigns a second weight to the job data by applying the user-defined weight table, and sums the first and the second weight to calculate a summed weight to determine the job processing order of the job data according to the summed weight.

20. The image forming apparatus of claim 19, wherein the job management part updates the job processing order when at least one of new job data and a new user-defined weight table is received from the at least one host computer.
